(19) United States
(12) Patent Application Publication
(10) Pub. No.: US 2024/0362075 A1
(43) Pub. Date: Oct. 31, 2024

(54) RESOURCE-SENSITIVE SHARD ALLOCATION AND AUTO-SCALING

(71) Applicant: ELASTICSEARCH B.V., Mountain View, CA (US)

(72) Inventors: David C. Turner, Otley (GB); Henning Andersen, Silkeborg (DK); Ievgen Degtiarenko, Berlin (DE); Francisco Fernández Castaño, Utrecht (NL)

(73) Assignee: ELASTICSEARCH B.V., Mountain View, CA (US)

(21) Appl. No.: 18/434,209

(22) Filed: Feb. 6, 2024

Related U.S. Application Data
(60) Provisional application No. 63/483,587, filed on Feb. 7, 2023.

(51) Int. Cl. G06F 9/50; G06F 11/34

(52) U.S. Cl. CPC G06F 9/505; G06F 9/5083; G06F 11/3452

(57) ABSTRACT

An automated system for allocation of resources in a cluster configured to run a search engine is disclosed. At least one master node includes a processing system. The processing system is configured to analyze the cluster based on measurements of different parameters. The results of the analysis can be used to allocate or reallocate the shards, allocate or reconfigure the workload portions assigned to the shards, and allocate or reconfigure the shards selectively to maintain high performance. Periodic analyses can predict future behavior, and reconciliations toward a target allocation can occur regularly to maximize system efficiency and performance.

### CROSS-REFERENCE TO RELATED APPLICATION

This application claims the benefit of, and right of priority to, U.S. Provisional Application Ser. No. 63/483,587 titled “RESOURCE-SENSITIVE SHARD ALLOCATION AND AUTO-SCALING” and filed Feb. 7, 2024, which is expressly incorporated by reference herein.

### FIELD

The present disclosure relates generally to cluster management, and more specifically to techniques for dynamically allocating shards among nodes in a cluster.

### BACKGROUND

Conventional enterprise search engines running on sophisticated server systems typically include a collection of nodes. Among these nodes, shards may be allocated and provided with the necessary processing, storage and other resources to meet their respective computational workloads. More often than not, in these current systems, shards are allocated to nodes based on the assumption that all shards have essentially equal needs for resources. The allocations also tend to be ad hoc in nature such that each allocation is executed for a specific or limited purpose, frequently in response to some type of emerging event or sudden computational need. As such, these systems often tend to be principally reactive in nature. One shortcoming associated with current resource allocating systems is that the assumptions made about shard resources are at best grossly oversimplified, and at worst erroneous. For example, an allocation based on these assumptions can operate to deprive certain shards of key resources that may be critical for performing high priority tasks. The same resources may instead be allocated to other shards that may not currently have any need for them. In addition, the ad hoc nature of allocations in these systems effectively ignores the longer term welfare of the cluster. While they may temporarily address sudden problems, they can equally cause the cluster to stray further from an ideal configuration as time passes and different resource-intensive challenges continue to emerge.

### SUMMARY

The present disclosure includes a cluster of networked nodes for running a distributed search engine. At least one master node includes a processing system for automatically running periodic analyses based on results of different measurement types. The analyses can be used to allocate or reconfigure shards across the nodes in the cluster. The processing system can partition the cluster's workload for allocating portions of the workload, or adding or removing workload portions, to or from the nodes. The analysis can also be used for selectively allocating and reconfiguring resources of the shards based on the individual needs of the shards. In some embodiments, the analyses can be used to predict future behavior. Reconciliations toward a target allocation are more seamless and envision longer term scenarios. The system can be self-8258 can take into account a larger number of criteria in making allocation decisions. For example, based on the results from different measured parameters, the system can conserve resources by reconfiguring shards, without interfering with the shard's performance. The system is consequently efficient in that it can selectively conserve resources, while reallocating those resources if necessary to shards on highly active nodes. That is, the system is not bound by old assumptions about the equal nature of shards, and resources can be judiciously distributed when they are actually needed.

In one aspect of the disclosure, a system for a distributed search engine includes a cluster comprising a plurality of networked nodes, the cluster having a workload. The system includes at least one master node including a processing system. The processing system is configured to automatedly analyze the cluster based on a plurality of measured parameters. The processing system can use results of the analysis to allocate shards across the nodes, partition a workload for allocating portions thereof among the shards, and selectively allocate resources to the shards sufficient to support the respective workload portions.

In various embodiments, the processing system may be configured to measure individual resource needs of the shards for selectively allocating the workload portions of the cluster or further resources, respectively, to individuals ones of the shards. The workload may include indexing, searching, and aggregations. In various embodiments, the plurality of measured parameters may include one or more of shard, node, or cluster-based: durable storage use or needs, indexing data, searching data, aggregation data, random access memory use or needs, times to perform tasks, thread data, refreshes, merges, read times, write times, processor statistics, or metadata relevant to any of the foregoing.

The processing system may be further configured to aggregate the plurality of measured parameters into statistics for use in predicting future allocations. In other embodiments, the processing system may be configured to predict future resource needs for each of the shards according to the results from the plurality of measurement types. The processing system may also be configured to determine a target allocation of shards to the plurality of nodes in the cluster, wherein each of the shards is allocated resources from the cluster needed for the shard based on the respective workload portion. The processing system may be further configured to periodically reconcile a current allocation of shards in the cluster towards the target allocation.

In still other embodiments, the processing system is configured to revise the target allocation of the shards to another target allocation in response to identifying changes in the resources allocated from the cluster to one or more of the shards. The processing system may also be configured to revise the target allocation of the shards to another target allocation in response to identifying changes in a workload of the cluster. In other embodiments, the processing system is configured to add or remove one or more of the plurality of nodes in the cluster while preserving sufficient resources for shards affected by the addition or removal.

In various embodiments, the processing system is further configured to adjust the resources allocated to each node while preserving sufficient resources for shards affected by the adjustment. The processing system may also be configured to adjust a strategy used to partition the workload of the cluster when the analysis shows that a new strategy will improve performance or reduce resources needed by the cluster or the plurality of nodes located therein.

In still other embodiments, the system includes an orchestrator configured to auto-scale the cluster, the auto-scaling comprising adding or removing nodes based on (i) actual or anticipated storage needs of the cluster, and (ii) actual or anticipated indexing needs of the cluster. The orchestrator may further be configured to auto-scale the cluster based on the amount of random access memory (RAM) needed for the shards. The orchestrator may be further configured to auto-scale the cluster based on the number of processors needed to manage a current workload in the cluster. The resources allocated to the shards may include at least one of: one or more central processing units (CPUs) or hardware computational resources, durable storage; random access memory (RAM); cache memory; or network resources.

In another aspect of the disclosure, a system for a distributed search engine includes a cluster including a plurality of networked nodes. The cluster has a workload assigned to shards in portions across the nodes. The system further includes at least one master node including a processing system. The processing system is configured to periodically analyze the cluster based on a plurality of measured parameters. The processing system can use results of the analysis to reallocate shards across the nodes when needed to improve performance or efficiency, allocate or reconfigure the workload portions among one or more of the shards, and selectively allocate or reconfigure resources to the shards sufficient to support the respective workload portions.

These features and advantages, along with other features and advantages of the present teachings, are readily apparent from the following detailed description of the modes for carrying out the present teachings when taken in connection with the accompanying drawings. It should be understood that even though the following figures and embodiments may be separately described, single features thereof may be combined to constitute additional embodiments.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 is a block diagram of an example node included in a larger cluster of a distributed search engine, according to some embodiments.

FIG. 2 is a schematic diagram of an example environment where aspects of the present disclosure can be practiced,

FIG. 3 is a conceptual diagram of a cluster environment for a system executing a distributed search engine.

FIG. 4 is a conceptual diagram for implementing data using shards on an instance of a cluster.

FIG. 5 is a block diagram of different servers implementing shards and replicas thereto.

FIG. 6 is an example screen shot of an Elasticsearch™ search engine user interface presenting various data and providing prompts.

FIGS. 7A and 7B are flowcharts illustrating example techniques for resource-sensitive shard allocation and auto-scaling according to various embodiments.

FIG. 8 is an example diagram of an external orchestrator used for configuring a cluster in accordance with various embodiments.

The figures are not necessarily to scale; some features may be exaggerated or minimized to show details of particular components and to avoid unduly obscuring the concepts of the disclosure. The appended drawings may instead present a simplified representation of various features of the present disclosure as disclosed herein. This simplified representation may include, for example, specific dimensions, orientations, locations, shapes and scales. Details associated with such features may be determined in part by the particular intended application and use environment.

### DETAILED DESCRIPTION

Detailed embodiments of the present disclosure are disclosed herein; however, it is to be understood that the disclosed embodiments are merely exemplary of the disclosure that may be embodied in various and alternative forms. Therefore, specific structural and functional details disclosed herein are not to be interpreted as limiting, but merely as a representative basis for teaching one skilled in the art to variously employ the principles of the present disclosure.

Modern search engines conventionally include a collection of nodes for performing computations. They divide their workloads up into indices, which in turn include shards. The shard includes the unit at which various search engines or other entities distribute data around the cluster. Systems may allocate shards to nodes such that ideally, each shard has the resources it needs. A shard can be considered a partition of data in a database or search engine. Each shard may be held on a distinct database server instance to spread the workload. Sharding, then, includes a technique used by these search engines or other database applications for scaling applications to allow them to support more data. As an example, large tables of data may be partitioned into smaller chunks (shards). The shards in turn can be allocated across one of a plurality of nodes. A node may include the necessary resources to support a server instance.

Shards may be moved around as necessary when rebalancing data, such as following a hardware failure or other error, or in the general course of maximizing the efficiency of the cluster of nodes in the system. Clusters generally include a collection of three or more nodes, with each cluster having a unique identification for accurate identification, although in some cases less than three nodes may be used in a cluster. In some configurations, a sophisticated search engine may include a plurality of clusters.

Aspects of the present disclosure improve the mechanism used to allocate shards to nodes. As such, aspects herein can improve the overall efficiency and processing power of the search engine or other functional entity while preventing the allocation of unnecessary resources. Further aspects of the disclosure may automatically adjust the resources available to the cluster, taking into account different considerations in the process. In various embodiments, as noted, data stored in the cluster is divided into shards, each of which supports some portion of the cluster's current workload. The workload is partitioned using certain logic-based criteria and portions of the workload can be allocated among the shards across the nodes.

In one aspect of the disclosure, a distributed search engine includes a collection of nodes which cooperates to execute and complete requests from clients. These client requests may include, among others, indexing (e.g., writing) data, searching the data that has already been indexed, computing aggregate statistics over the indexed data, and performing various management operations, for example, to enable the system to automatedly adjust how the data is stored and retrieved. Indexing more formally includes processes by which search engines and related functional entities organize and write relevant data in some manner prior to the actual execution of a search, for example, to enable the search engine to provide fast responses to subsequent searches.

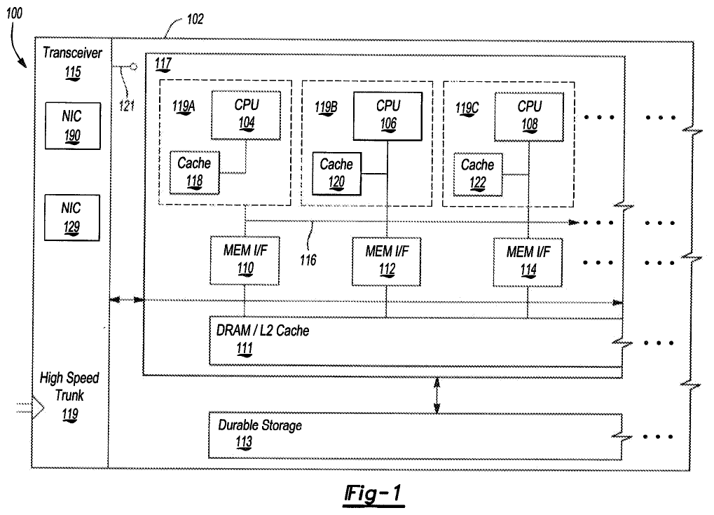

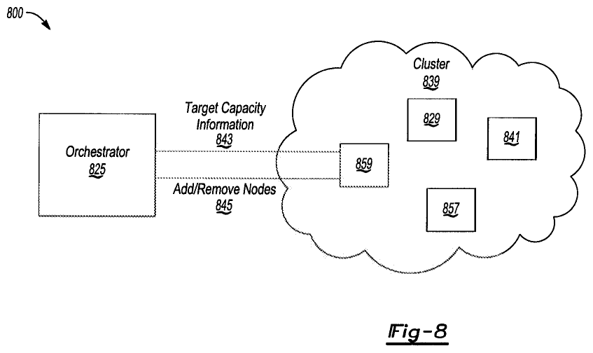

FIG. 1 is a block diagram 100 of an example node 102 included in a larger cluster of a distributed search engine, according to some embodiments. Node 102 may be included as part of a larger plurality of nodes that make up the cluster. In some embodiments, node 102 may execute a suite of algorithms for automatically rebalancing the cluster, as described in greater detail herein. In those embodiments, node 102 may or may not be specifically part of the cluster may include one or more physical devices. In other cases, node 102 is a standard data node in a cluster and used to store shards and indices for use in client searches. A cluster or collection of nodes such as node 102 may reside in a cloud, whether proprietary or otherwise. The cloud may provide adequate storage space and server computing power to enable implementation of the system described in this disclosure, for example. Other locations may be equally suitable. The node 102 may be a data node, a master-eligible node, or another type of node as described herein. The node 102 may be an orchestrator (FIG. 8). The identity of node 102 depends on the functions it performs. In some cases, it may perform multiple functions. Some functions may not be directly related to storing data for client search purposes.

Each node in the cluster, such as node 102, may have access to computational resources for shards that reside on the node 102. Each node 102 may include a processing system 117. Processing system 117 may include one or more processors (e.g., processors 119a, 119b and 119c). Each processor, in turn, may include one or more central processing units (CPUs) 104, 106, 108, and the like. While a wide variety of computer architectures with different configurations are possible, the processors 119a, 119b and 119c, in FIG. 1 may each include local caches 118, 120, and 122, respectively to accommodate frequently used code and data. The number of active CPUs may in some embodiments be regulated by a quota mechanism. For example, different nodes may include different processors or CPU models that have different performance characteristics such as different clock speeds, number of on-CPU caches, and similar specifications. The processing system 117 in some cases may be used to perform empirical analyses and perform various measurements as described in greater detail below. The processing system may also be configured to perform one or more analyses and to perform allocations or reconfigurations of resources. As noted, in other cases the processing system and node 102 may be used to store data and shards.

The processors 119a, 119b and 119c may be coupled to dynamic random access memory (DRAM) 111 via respective memory interface chips 110, 112, and 114. Bus 116 may be used to transfer data and control signals between the processors 119a-c and the DRAM 111. The processors and interface circuits may have other connections (not shown) for accommodating other types of data transfers, e.g., to receive power, etc. DRAM 111 may include an L2 cache for storing frequently-used instructions and data. In other examples, the system main memory and cache memory are located in different components. In still other embodiments, SRAM may additionally or alternatively be used for effecting fast reads and writes. The amount of physical RAM may be subject to implementation-dependent quotas. Portions of the RAM may be allocated to the node's heap. Other portions of RAM may be used for caching data read from or written to durable storage 113, below.

Durable storage 113 may be used to store indices and shards, depending on the constitution of the particular implementation. Metadata and data may be stored in durable storage 113 in each node, including node 102 for use in searches. Executable code may also reside in durable storage 113, including in the case where node 102 is responsible for allocating resources in the system. In that case, node 102 may be a specialized device that does not necessarily store data used in searches. These issues are discussed further below.

Processing system 117 may be further coupled to a transceiver 115. The transceiver 115 may act as an interface for the node 102 to communicate with other nodes in the cluster, and with the Internet. The transceiver 115 may, for example, include one or more network interface cards (NICs) 190 and 129 to transfer data over distinct types of high-speed connected networks using one or more wired or wireless network protocols. Networked nodes for purposes of this disclosure includes the use of cables (such as high speed trunk interface 119) coupled directly between devices that are local relative to one another. Transceiver 115 may also include an antenna 121 and for transferring typically high-speed data a wireless network. Data may be locally or remotely transferred over a fiber optic cable, using a compatible interface. The protocol used to transfer data between nodes may vary widely without departing from the scope of the present disclosure. The transceiver 115 enables node 102 to communicate with other nodes in the cluster (and with external systems) via the one or more network interfaces. Depending on the strategy adopted by the system including the allocation of shards and the designated purpose of a particular node, the transceiver 115 may use different network interfaces having different performance characteristics (bandwidth, latency, ability to offload tasks, etc.).

Referring still to FIG. 1, the processing system 117 as noted may be coupled to durable storage 113, or an array of storage units. Unlike DRAM, which may be used in addition to the cache memory to read and store open programs and data and for executing high-speed tasks in or near real time, the durable storage 113 is intended to be more permanent in the sense that indexed, configured and/or archived data can be stored in the durable storage 113. Durable storage 113 may include, for example one or more (or an array) of solid state drives, magnetic disk drives, NAND and NOR flash memories, and other forms of non-volatile memory. While shown as one block, the durable storage 113 can in practice be partitioned into a larger array of individual components, with some blocks used for backup, e.g., for storing replica shards. Typically, some form of data redundancy is built in on distributed search engines, such as on this node 102 or on another adjacent node in the cluster, for example. Redundant array of inexpensive disks (RAID) systems may be used for security and/or to enhance speed into and out of durable storage, as one example. Other public or proprietary redundancy systems may also be used.

In some embodiments, the durable storage on any given node may be limited via a quota mechanism, with different models of durable storage having different performance characteristics (bandwidth, latency of operations, and solid-state drives vs spinning-disks).

It will be appreciated that the terms “processing system” and “processor” for purposes of this disclosure may not simply be limited to a single processor or integrated circuit but may encompass plural or multiple processors and/or a variety of different physical circuit configurations. Non-exhaustive examples of the “processor” include (1) a plurality of processors in the vehicle that collectively perform the web-crawling, indexing, archiving, and other search-related tasks, and (2) processors of different types, including reduced instruction set computer (RISC)-based processors, complex instruction-set computer (CISC)-based processors, etc. The allocation of resources and related tasks described herein may be executed in software, hardware, firmware, middleware, application programming interfaces (APIs), or some combination thereof. The processing system may perform tasks using a layered architecture, with operating system code configured to communicate with driver software of physical layer devices, or with dedicated hardware or a combination thereof.

The processing system may further include memory (e.g., dynamic or static random access memory (“DRAM” or “SRAM”) as noted above. While the embodiment of FIG. 1 shows a separate processing system 117 and durable storage 113, in other implementations the two structures may share physical resources at least in part. For example, the processing system 117 may also include solid state drives, magnetic disk drives and other hard drives. The processing system 117 may also incorporate flash memory including NAND memory, NOR memory and other types of available memory. The processing system 117 may also include read only memory (ROM), programmable ROM, electrically erasable ROM (EEROM), and other available types of ROM. The processing system and the operating system and other applications relevant to the search engine functionality may be updateable, wirelessly via a network or otherwise. As noted, the memory (e.g., DRAM 111) in the processing system may further include one or more cache memories, which may also be integrated into one or more individual processors/central processing units (CPUs) as L1 caches (not shown), which may also be discrete devices, or some combination of both.

The processing system in some implementations may include a system-on-a-chip (SoC), or more than one SoC for performing dedicated or distributed functions. Thus, as noted, the “processing system” in this disclosure may be implemented in software, or a combination of software and hardware in different possible ratios include hardware implementations such as digital signal processors (DSPs), application-specific integrated circuits (ASICs), field programmable gate arrays (FPGAs), discrete combinational logic circuits, and the like. In these configurations, the processors may be coupled together via different circuit boards to form the processing system. In other embodiments, these hardware circuits may be used along with actuators and other components to assist in various measurements that the processing system may elect to make.

The nodes in the cluster may be collected together into “tiers” with broadly similar resource profiles. For instance, a node in a “hot” tier may have plenty of CPU and expensive high-performance storage and therefore be best suited for heavy indexing and search workloads, but that same node may have relatively little storage space to limit costs. In contrast, a node in a “warm” tier may have much more storage space than nodes in the hot tier, but the storage performance will be lower, and it will have fewer or slower CPUs suited for long time search only access. A cold tier may also be present in some arrangements.

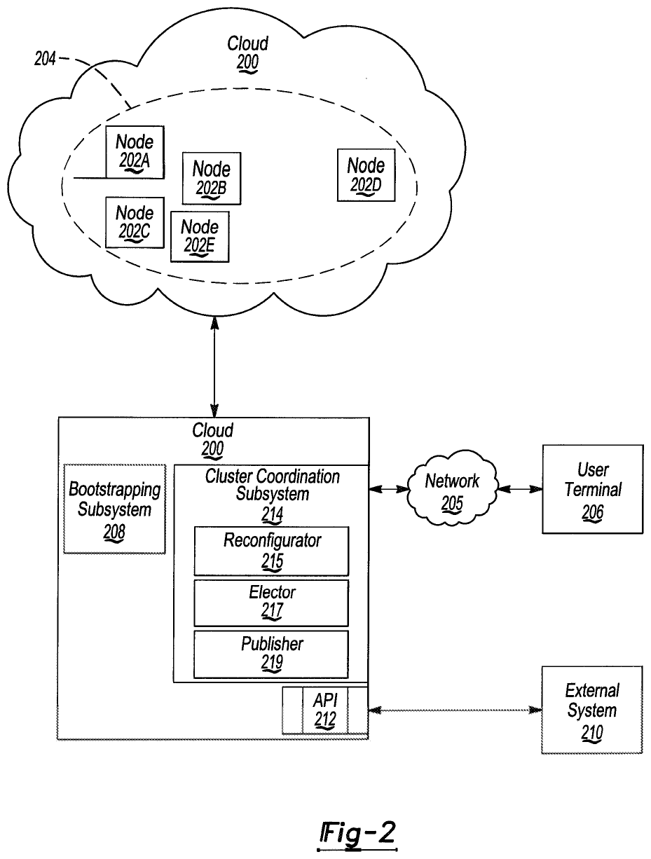

FIG. 2 is a schematic diagram of an example environment where aspects of the present disclosure can be practiced. That is, FIG. 2 is an example working environment of a cluster 204 of nodes, and a separate system of control devices, all in a secure cloud environment. FIG. 2 demonstrates certain features and aspects of the system. The environment includes a distributed computing environment such as a cloud 200. The cloud 200 can host many nodes, such as nodes 202A-202E that can create the cluster 204. A user terminal 206 can access the cluster 204 to enable a user to use various services, such as Elasticsearch™ services. The user terminal 206 can communicatively couple with the cloud 200 over any public or private network 205, including a plurality of networks.

In some embodiments, the cluster 204 can perform many tasks that require a number of nodes to work together, such as any one or more of nodes 202A-202E. For example, a search can be routed to all the right shards to ensure that its results are accurate.

A client request, such as a search request, can be forwarded from the node that receives it to the node(s) that can handle it. The nodes 202A-E each have an overview of the cluster so that they can perform searches, indexing, and other coordinated activities. This overview is known as the cluster state. The cluster state determines attributes such as mappings and settings for each index, shards that are allocated to each node, and the shard copies that are in-sync. Ideally this information is kept consistent across the cluster 204.

In general, a node can have a role as a master-eligible node, a voting-only node, as well as non-master-eligible nodes such as data nodes, ingest nodes, coordinating nodes, and machine learning nodes. For example, nodes 202A-202C are master-eligible nodes in the cluster 204. It is also possible that each of the nodes 202A-202E are master-eligible nodes, but each can also assume other roles, in some embodiments. In other embodiments, the cluster can comprise additional non-master-eligible nodes. While fewer or more master-eligible nodes can be present, the cloud 200 can apply rules to ignore certain master-eligible nodes when an even number of nodes are present, as will be discussed below.

These various node roles can include a data node that can hold data shards that contain documents that have been indexed by a user. An ingest node can execute pre-processing pipelines, composed of one or more ingest processors. A coordinating node can route requests, handle a search reduce phase, and distribute bulk indexing. Coordinating only nodes behave as smart load balancers. The processing system 117 may be included as part of a “coordinating node” or sometimes, a “coordinating only node.” Machine learning nodes can be configured to perform any desired machine learning function, as defined by a user or otherwise. To be sure, a user can change the role of a node as needed. In some embodiments, data nodes and master-eligible nodes can be provided access to a data directory where shards, indices and cluster metadata can be stored.

In general, a master-eligible node is a node that is responsible for lightweight cluster-wide actions such as creating or deleting an index, tracking which nodes are part of the cluster, and deciding which shards to allocate to which nodes. Any master-eligible node that is not a voting-only master-eligible node may be elected to become the master node by the master election process. A voting-only master-eligible node is a node that participates in master elections, but which may not act as a cluster's elected master node. In particular, a voting-only node can serve as a tiebreaker in elections. A master-eligible node may be a candidate for the processing system 117 of FIG. 1 in the context of performing tasks described herein that relate to the resource-sensitive allocation/reconfiguration of shards, workloads and resources. Shards may be allocated and reallocated to improve cluster performance or resource efficiency. For example, if an analysis determines that a data node can perform more efficiently using a different allocation of shards, the reallocation may result in improved resource efficiency for the node.

An election process can be used to agree on an elected master node, both at startup and if the existing elected master fails. Any master-eligible node can start an election, and normally the first election that takes place will succeed. Elections only usually fail when two nodes both happen to start their elections at about the same time, so elections are scheduled randomly on each node to reduce the probability of a stalemate. Nodes will retry elections until a master is elected, backing off on failure, so that eventually an election will succeed (with arbitrarily high probability). The scheduling of master elections are controlled by the master election settings. These schedules can specify wait times before election failures are identified and election processes retried by a node. These time frames can range from milliseconds to seconds in duration.

High availability clusters may include at least three master-eligible nodes, at least two of which are not voting-only nodes. Such a cluster will be able to elect a master node even if one of the nodes fails. Since voting-only nodes may not act as the cluster's elected master, they may require less memory and a less powerful CPU than the true master nodes. However, master-eligible nodes, including voting-only nodes, may use reasonably fast persistent storage and a reliable and low-latency network connection to the rest of the cluster, since they are on a critical path for publishing cluster state updates.

Voting-only master-eligible nodes may also fill other roles in the cluster 204. For instance, a node may be both a data node and a voting-only master-eligible node. A dedicated voting-only master-eligible node is a voting-only master-eligible node that fills no other roles in the cluster.

In some embodiments, a node can have all the following roles: master-eligible, data, ingest, and machine learning. For larger clusters, it may be preferable to have specialized nodes, assigning dedicated role types to nodes. As noted above, the master node is responsible for lightweight cluster-wide actions such as creating or deleting an index, tracking which nodes are included in the cluster, and deciding which shards to allocate to which nodes.

Electing a master node and changing the cluster state (e.g., voting configuration) are the two tasks that master-eligible nodes can work together to perform. It is important that these activities work robustly even if some nodes have failed. This robustness is achieved by considering each action to have succeeded based on receipt of responses from a quorum, which is a subset of the master-eligible nodes in the cluster.

The advantage of utilizing only a subset of the nodes in a cluster to respond is that it means some of the nodes can fail without preventing the cluster from making progress. The quorums are carefully chosen so the cluster does not have a “split brain” scenario where it is partitioned into two pieces such that each piece may make decisions that are inconsistent with those of the other piece. The quorums are defined through a voting configuration, which is the set of master-eligible nodes whose responses are counted when making decisions such as electing a new master or committing a new cluster state. Decisions are made only after a majority of the nodes in the voting configuration respond. A quorum is therefore defined to be a majority of the voting configuration.

Consistency is achieved through this process because no matter how a cluster is partitioned, no more than one part can contain a majority of the voting configuration. Thus, no part may contain a majority and in that case the cluster cannot continue operating until the partition is healed. Nodes can be identified in the voting configuration using their persistent node ID, a universally unique identifier (UUID) which is unique for each node, generated the very first time the node is started and persisted in its data folder to survive restarts.

Starting a cluster, such as the cluster 204, for the very first time includes establishing an initial voting configuration. This is known as cluster bootstrapping and is utilized the very first time the cluster 204 starts up. Nodes that have already joined a cluster store bootstrapping information in their data folder for use in a full cluster restart, and freshly-started nodes that are joining a running cluster obtain this information from the cluster's elected master. Master node election processes are described in greater detail herein, but in general can be mediated by an elector 217 of the cluster coordination subsystem 214.

Changes to the cluster 204, such as after a node joins or leaves the cluster 204 can trigger a reconfiguration of the voting configuration. In some embodiments, the reconfiguration of the voting configuration can be performed by a reconfigurator 215, which can be invoked by the cluster coordination subsystem 214 based on detected changes to the cluster 204.

Changes to the voting configuration can be automatically propagated to the nodes of the cluster through a publisher 219 of the cluster coordination subsystem 214. In some embodiments, the publisher 219 can cause automatic propagation of corresponding changes to the voting configuration in order to ensure that the cluster 204 is as resilient as possible. This is also called auto-reconfiguration as the cluster automatically reconfigures the set of master-eligible nodes whose responses are counted when making decisions at the cluster level. Larger voting configurations are usually more resilient, so the preference is to add master-eligible nodes to the voting configuration after they join the cluster.

Similarly, if a node in the voting configuration leaves the cluster and there is another master-eligible node in the cluster that is not in the voting configuration then it is preferable to swap these two nodes over. A size of the voting configuration is thus unchanged but its resilience increases.

In various embodiments, the cloud 200 can include a bootstrapping subsystem 208. It will be understood that a bootstrap configuration can identify which nodes should vote in a first election. It is also important to note that the bootstrap configuration can originate from outside the cluster, such as through the user terminal. That is, the user can initially establish the bootstrap configuration for the cluster 204. In some embodiments, the cluster can determine a bootstrap configuration correctly on its own, such as by maintaining and applying a prior bootstrap configuration.

The initial set of master-eligible nodes is defined in a set of initial master nodes settings. This should be set to a list containing one of the following items for each master-eligible node, allowing that node to be uniquely identified: (a) a node name (node.name) of the node, configured by a user; (b) a node's hostname if the node name is not set, because the node name defaults to the node's hostname (the user can use either a fully-qualified hostname or a bare hostname); (c) an IP (Internet Protocol) address of the node's publish address, if it is not possible to use the node.name of the node (this is normally the IP address which network.host resolves but this can be overridden); and (d) an IP address and port of the node's publish address, in the form of IP:PORT, if it is not possible to use the node.name of the node and there are multiple nodes sharing a single IP address.

When a master-eligible node is initiated, the user can provide this setting on the command line or in the human-readable data-serialization language file. In another embodiment, bootstrapping can be triggered by an external system 210. For example, an existing cluster can establish bootstrapping configurations for a new cluster. Bootstrapping configurations can be provided by any external system using an application programming interface (API) providing access to the cloud 200. For example, an external system 210 can couple to the cloud 200 through an API 212 to provide bootstrapping configurations to the cluster 204.

After the cluster has been initiated, this setting is no longer required. It need not be set on master-ineligible nodes, nor on master-eligible nodes that have started to join an existing cluster. As noted above, master-eligible nodes can use storage that persists across restarts. If they do not, and the initial master nodes settings is reset and a full cluster restart occurs, then another brand-new cluster is formed and this may result in data loss.

In some embodiments it is sufficient to set initial master nodes settings on a single master-eligible node in the cluster, and only to mention that single node in the setting's value, but this provides no fault tolerance before the cluster has fully formed. It is therefore preferred to bootstrap using at least three master-eligible nodes, each with initial master nodes settings comprising these three nodes.

The bootstrap process includes resolving a list of names for nodes in the initial master nodes settings to their persistent node IDs after discovery. Discovery includes the process by which a node finds other nodes with which to potentially form a cluster. This process can be performed when a node is created or when a node believes the master node has failed and continues until the master node is found or a new master node is elected. The node can identify a set of other nodes, together with their node name, publish address, as well as their persistent node ID.

In cases where not all names in initial master nodes settings can be resolved using the discovered nodes, but at least a majority of the entries have been resolved to their persistent node ID, the remaining names can be added as place holders to the voting configuration, to be resolved later. This allows a cluster with at least three nodes (and initial master nodes settings set to the names of these three nodes) to fully bootstrap as soon as two out of the three nodes have found each other through the discovery process.

When bootstrapping is correctly configured, with each name uniquely identifying a node, then this process is safe, which means that at most one cluster will be formed, even in the presence of network partitions or nodes crashing or restarting. The process is also eventually successful, as long as a majority of nodes that are referenced in the initial master nodes settings are available.

According to some embodiments, the bootstrapping subsystem 208 can execute an auto-bootstrapping in certain circumstances. If the cluster 204 is running with a completely default configuration then it will automatically bootstrap a cluster based on the nodes that could be discovered to be running on the same host within a short time after startup. This means that by default it is possible to start up several nodes on a single machine and have them automatically form a cluster, which is very useful for development environments and experimentation.

### Automatic Reconfiguration

Node identifier(s) referred to in the voting configuration are not necessarily the same as the set of taking a vote, so it takes some time to adjust the configuration as nodes join or leave the cluster 204. Also, there are situations where the most resilient configuration includes unavailable nodes or does not include some available nodes. In these situations, the voting configuration may differ from the set of available master-eligible nodes in the cluster 204.

The best possible voting configuration can be selected based on a number of factors, some of which are configurable. No matter how it is configured, the cluster 204 will not suffer from a “split-brain” inconsistency. Only the availability of the cluster is affected in the case where some of the nodes in the cluster are unavailable.

In some embodiments, there should normally be an odd number of master-eligible nodes in a cluster. If there is an even number, one of the nodes can be excluded from the voting configuration to ensure that it has an odd size. This omission does not decrease the failure-tolerance of the cluster 204. In fact, it improves it slightly. For example, if the cluster 204 suffers from a network partition that divides it into two equally sized halves, then one of the halves will contain a majority of the voting configuration and will be able to keep operating. If all of the votes from master-eligible nodes were counted, neither side would contain a strict majority of the nodes and the cluster would not be able to make any progress.

For instance, if there are four master-eligible nodes in a cluster and the voting configuration contains all of them, any quorum-based decision would require votes from at least three of them. This situation means that the cluster can tolerate the loss of only a single master-eligible node. If this cluster were split into two equal halves, neither half would contain three master-eligible nodes and the cluster would not be able to make any progress. If the voting configuration contains only three of the four master-eligible nodes, however, the cluster is still only fully tolerant to the loss of one node, but quorum-based decisions require votes from two of the three voting nodes. In the event of an even split, one half will contain two of the three voting nodes so that half will remain available.

In general, larger voting configurations are usually more resilient, so there is a preference to add master-eligible nodes to the voting configuration after such nodes join the cluster. Similarly, if a node in the voting configuration leaves the cluster and there is another master-eligible node in the cluster that is not in the voting configuration then it is preferable to swap these two nodes over. The size of the voting configuration is thus unchanged, but its resilience increases.

There are several options for automatically removing nodes from the voting configuration after they have left the cluster. Different strategies have different benefits and drawbacks, so the right choice depends on how the cluster will be used. A user can control whether the voting configuration automatically shrinks by using the cluster shrinking setting. If cluster shrinking is enabled and there are at least three master-eligible nodes in the cluster, the cluster 204 remains capable of processing cluster state updates as long as all but one of its master-eligible nodes are healthy. There are situations in which the cluster 204 might tolerate the loss of multiple nodes, but this is not guaranteed under all sequences of failures. If the cluster shrinking setting is set to “false,” the user can remove departed nodes from the voting configuration manually.

In order to avoid unnecessary reconfiguration steps, the cluster prefers to keep existing nodes in the voting configuration. These rules provide a very intuitive behavior for running clusters. If a user desires to add some nodes to a cluster, the user can configure the new nodes to find the existing cluster and start them up. New nodes can be added to the voting configuration if it is appropriate to do so. When removing master-eligible nodes, it is important not to remove half or more of the master-eligible nodes all at the same time. For instance, if there are currently seven master-eligible nodes and the user desires to reduce this to three it is not possible simply to stop four of the nodes at once. To do so would leave only three nodes remaining, which is less than half of the voting configuration, which means the cluster cannot take any further actions. By only shutting down three nodes at once, the cluster 204 can auto-reconfigure, subsequently allowing the shutdown of further nodes without affecting the cluster's availability.

As noted above, the cluster 204 can implement an API to manually influence a voting configuration. In some instances, the user can define a list of nodes to exclude from the voting configuration. If the user desires to shrink the voting configuration to contain fewer than three nodes or to remove half or more of the master-eligible nodes in the cluster at once, the user can use the API to remove departed nodes from the voting configuration manually. The API adds an entry for that node in the voting configuration exclusions list. The cluster then tries to reconfigure the voting configuration to remove that node and to prevent it from returning.

The API waits for the system to auto-reconfigure the node out of the voting configuration up to the default timeout of 30 seconds. If the API fails, it can be safely retried. Only a successful response guarantees that the node has been removed from the voting configuration and will not be reinstated.

According to some embodiments, the cluster 204 can be reconfigured to increase the level of the cluster's fault tolerance. A cluster coordination subsystem 214 is used to allow nodes in the cluster to share a strongly consistent view of metadata. In general, metadata contains information about which nodes are part of the cluster, what indices exist, what their mappings (schemata) are, which shards are allocated to which nodes (e.g., where the different partitions of the data reside), and which shard copies are considered in-sync (contain the most recent writes). Inconsistencies at the metadata layer can lead to data loss at the data layer. The metadata is captured in an object which is called the cluster state. This object is shared by and available on all nodes in the cluster, and the object over which the master-eligible nodes coordinate. The voting configuration is contained in this cluster state object.

The master node is the only node in a cluster that can make changes to the cluster state. The master node processes one batch of cluster state updates at a time, computing the required changes and publishing the updated cluster state to all the other nodes in the cluster. A publication starts with the master node broadcasting the updated cluster state to all nodes in the cluster. Each other node in the cluster responds with an acknowledgement but does not yet apply the newly-received state. Once the master node has collected acknowledgements from a quorum of nodes in the voting configuration, the new cluster state is said to be committed and the master node broadcasts another message instructing the other nodes to apply the now-committed state. Each node receives this message, applies the updated state, and then sends a second acknowledgement back to the master node.

To allow reconfiguration, the cluster state can comprise two voting configurations, the one that's currently active, called the last committed configuration, and a future target configuration, called the last accepted configuration. In a stable state, both configurations can be equal.

Decisions during a reconfiguration can involve a majority of votes in the current configuration as well as the target configuration. This ensures that a majority of nodes in the last committed configuration become aware that future decisions must include a majority of nodes in the new, last accepted configuration as well as that a majority of nodes in the new last accepted configuration are aware of the last committed configuration, making them aware that they cannot proceed with making decisions purely based on the new configuration until these nodes have heard from a majority in the old configuration that they have learned about the new configuration (i.e., that the last accepted configuration becomes committed). Regardless of the reconfiguration, one parameter of a suitable reconfiguration is the maintenance of an optimal level of fault tolerance in the cluster.

An ongoing reconfiguration process needs to complete before another one can be started. Changes to the cluster state are then committed once they have been accepted by a majority of nodes in the last committed configuration, as well as a majority of nodes in the last accepted configuration. Master elections also now require a majority of votes from nodes in the last committed configuration as well as a majority of votes from nodes in the last accepted configuration.

As noted above, the reconfiguration process is safe, ensuring that even in the presence of network partitions and nodes crashing or restarting, the cluster never ends up in a split-brain situation where it would have two masters making inconsistent decisions, ultimately leading to data loss. Also, as long as a majority of nodes in the last committed configuration as well as a majority of nodes in the last accepted configuration are available, the cluster can make progress, complete a reconfiguration and continue to make changes to the cluster state.

In some embodiments, a user can perform unsafe operations on a node. In order to prevent performing unsafe operations, the node should be in a shut-down state. Unsafe operations can include adjusting the role of a node and/or recovering some data after a disaster or starting a node even if it is incompatible with the data on disk, etc.

The above description discloses, among other things, a separate orchestrator process that controls the nodes in the cluster and their resources. For instance, the orchestrator may add or remove nodes, or may add or remove resources from existing nodes, according to some stimuli. Aspects are now disclosed for a system for automating some of these capabilities relevant to resource control and shard allocation in a manner that allows the search engine to be automatically operating in an optimal manner in view of not only immediate adjustments, but wider predictions and assessments that lead to a more efficient and robust search techniques without overutilizing valuable resources.

It will be appreciated that the above configuration of the cluster is but one of many that are possible, and that the description of the cluster above is presented for illustrative purposes.

### Shard Allocation

Different shards have different resource needs depending on the workload. The resource needs of individual shards may change over time. Aspects of the present disclosure address the following problems that are left unaddressed in conventional solutions: (i) to allocate shards to nodes such that all shards have access to the resources they need to support their workload; (ii) to minimize the total resources in the cluster, and therefore its operational costs, without starving any shards of resources; (iii) to react to unexpected changes in resource needs, and reactively adjust the resources in the cluster according to its immediate needs; (iv) to predict changes in resource needs over time, and proactively adjust the resources in the cluster according to its predicted needs; and (v) to adjust the strategy by which the cluster's workload is divided into shards, where such adjustments would improve performance or reduce the cluster's overall resource needs. These aspects are intended to introduce these improvements as part of an integrated, automated solution that effectively merges the immediate needs of the cluster with a long term vision for successful balancing and efficient growth. Further, unlike in previous search engine implementations, these automated procedures include reducing resources for shards that do not need them. The resources are then distributed to other shards that need them or are not used until needed.

As noted, conventional distributed search engines use routines that tend to allocate shards to nodes based on the incorrect assumption that all shards have roughly equal resource needs, and that all nodes in each tier of the cluster have access to roughly equal resources. Further, as noted, the algorithms in these conventional systems allocate shards to nodes by repeatedly making a small number of ad-hoc allocation decisions based on the current state of the cluster. By contrast, these search engines do not automatically try and minimize total resources. The same search engines also generally lack the capability to add resources as needed to cope with unexpected or predicted changes in future loads. At most, present search engines consider the single criterion of storage space when performing auto-scaling operations. Auto-scaling based on a single criterion fails to consider other potentially highly relevant resources that could otherwise effectively accommodate an increased workload. Enhanced processing power to effectively manage tasks like indexing can be one such advantage. Other criteria such as random access memory and networking resources are, or should be, relevant to auto-scaling.

In various aspects of the disclosure, a distributed system for a search engine is introduced herein that overcomes the above-stated problems. In short, the system as introduced can perform a variety of automated techniques during the period of activity of the search engine. The system can perform the following tasks automatically, obviating the need in most cases for any human intervention. In one such aspect, the processing system may empirically measure the resource needs for individual segments or portions of the overall workload on individual shards. The system may perform an analysis based on various measured parameters of interest. Examples of these empirical measurements may include, for example, measuring different criteria relevant to indexing, searching, aggregations, queries performed on individual shards, and resources allocated at an earlier time by the system. Aggregations collect the search results for a particular query from different search sources. As such, aggregations enable the search engine to extract valuable statistics and analytical insights based on results of search queries. They also potentially provide a transparent way to increase the number of relevant results that a searcher can achieve.

Using these empirical measurements, the system according to various embodiments allocates/reallocates shards to nodes, and resources to shards. The system may also predict the future resource needs for each shard and act proactively to adjust the resources in advance. To this end, and based on empirical measurements, the system may compute an overall target allocation of shards to the nodes in the cluster such that every shard has all the resources it needs, but not substantially more. This approach stands in contrast to existing approaches, which treat all shards as being equally likely to use the same amount and types of resources. In other aspects, the system progressively reconciles the actual allocation of shards in the cluster towards the desired allocation. Thus, the system may capitalize on idle time or scheduled time periods to react to changes in the workload or resources of a cluster by recomputing the desired allocation of shards. As such, the system may add or remove nodes in the cluster. Additionally, the system may adjust the number, amount and type of resources allocated to each node. One consequence of performing analytic-based allocations is that unlike prior techniques, the system can reduce unnecessary operating costs by preserving resources, and without depriving the shards of needed resources. These actions result in the system automatedly reducing operating costs, but without depriving any shards of the resources they need during ongoing activity. Thus, high efficiency is maintained. In other aspects, the system adjusts midstream the allocation strategy—that is, the strategy used to divide the cluster's workload into shards, where the system determines that such adjustments would improve performance or reduce the cluster's overall resource needs.

In sum, aspects of the present disclosure represent a significant departure from the conventional techniques of allocating shards as more data becomes available and leaving the search engine more or less to its own devices until an issue is recognized that requires a fix, addition, or change. With its predictive nature based on measurements collected over time, the system according to various aspects can reduce the total number of ad hoc fixes as it anticipates the need to address potential problems in advance. The system can meanwhile transfer resources that are currently idle to nodes that may be better suited to more computationally intensive tasks. The system can also remove resources from shards that can reliably remain idle until they are needed again. These strategies increase the efficiency of the system.

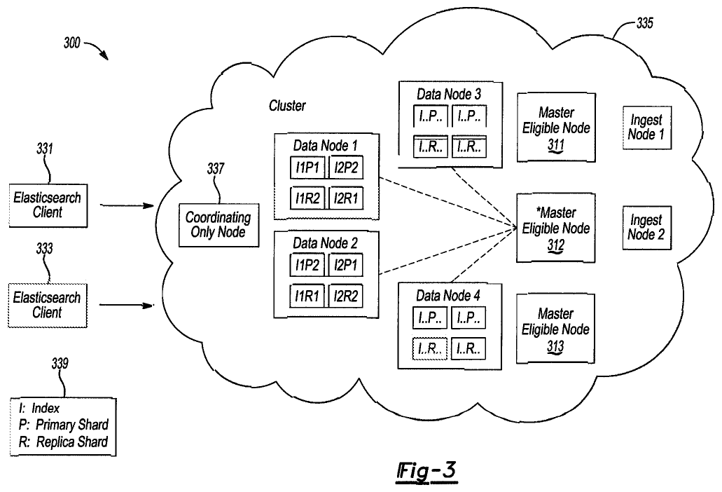

FIG. 3 is a conceptual diagram 300 of a cluster environment for a system executing a distributed search engine. A cluster 335 may include a plurality of networked nodes. These may include, for example, coordinating only node 337, data nodes 1-4, master eligible nodes 311, 312, and 313, and ingest nodes 1 and 2. The distributed search engine executed on the cluster 335 may be accessed by clients 331 and 333. It should be noted that a “plurality of nodes” may include those nodes to which indices shards are allocated/reconfigured. Each of the aforementioned nodes may be running on separate machines, such as the node 102 (FIG. 1). It will be noted that the number of nodes may differ depending on the nature of the configuration. A large enterprise distributed search engine, for example, may include many more nodes than as shown in FIG. 3. Also, while the nodes may be networked together in a common area such as a building, in other configurations the nodes may be located in different regions. The nodes can use any manner of networking that enables them to exchange data effectively and reliably (shown, for example, by the dashed lines in FIG. 3), whether on a local cloud platform or over long distances.

Referring to FIG. 3, the cluster 335 includes three master-eligible nodes 311, 312 and 313. The master node, as in FIG. 2, may perform tasks used for various cluster operations. Examples may include creating indexes, deleting indexes, tracking the location on the nodes of the plurality of allocated shards, tracking data nodes, and, in some embodiments, collecting measurement data of different parameters used for an empirical analysis. While master-eligible node 312 is operating, in other cases nodes 311 or 313 may take on the role of node 312. Under a voting scheme as generally described with reference to FIG. 2, another of the master nodes 311 or 313 may be elected to be the new master node. In various embodiments, nodes 311 and 313 may perform other tasks relevant to the cluster or the activities described herein. In an embodiment, one or more of nodes 311-313 may include the processing system (or a portion thereof) that performs the ongoing empirical analyses, data measurements, and automated allocation/reallocation strategies described herein. In other embodiments, these techniques may be performed by another node. The architecture and details of FIG. 3 are for exemplary purposes, and in other cases the cluster 335 may include additional or different features.

The data nodes 1-4 include durable storage and/or memory that preserves the indexed documents. These nodes may perform the create, read, update and delete-related operations requested by a user of the search engine or, for creating, updating and deleting operations performed by an administrator or by the processing system. These data nodes may also manage aggregations. The types of activities managed by the data nodes, and the resources allocated for these nodes may be managed by the processing system and/or one or more master nodes, etc. In various embodiments, the search engine may be organized by indices, with each index allocated memory in which organized data can be stored. An index may include one or more shards. A shard may use a specific data structure to store data. In some embodiments, an inverted index may be used. Shards may be partitioned into smaller segments in some embodiments.

As shown by the legend 339, each of the data nodes 1-4 may include one or more shards, e.g., I1P1 on data node 1. In this example, the I1 describes index information (e.g., the I in I1P1 on data node 1) relevant to primary shard P1. In the example embodiment shown, data node 1 includes two primary shards (I1P1 and I2P2) and corresponding indexing data, and two replica shards I1R2 and I2R1. The replica shards on data node 1 are counterparts to the primary shards I1P2 and I2R2, respectively, that reside on data node 2. Data nodes 3 and 4 may use a similar format. Using this or a similar approach, the processing system can ensure that the cluster 335 has adequate redundancy built into the constituent nodes. It will be appreciated that, while two primary shards are shown for example on each of the four data nodes, the number of nodes and the number of shards residing on the nodes may be different. While replica shards may be desirable, in some cases they may not be used. It should be understood, however, that multiple replicas of each shard may be used. The example configuration of FIG. 3 also shows the benefits of ensuring that a given primary node has its replica on another node (e.g. Data node 1 includes I2P2, the latter of which has replica I2R2 on data node 2. In the event of node failure, then the other node with the shard replica (or primary version) is still available. Another shard can then be created in its place.

Ingest nodes 1 and 2 may be included in some configurations. As in FIG. 2, ingest nodes may be used to process data prior to indexing the data in one of the data nodes. Coordinating only node 337 may also be present to perform search reduction, requests for routing, assistance in indexing, and similar tasks. The processing system may be a unique node within the cluster 335, or it may be located strategically for easy access. In various embodiments, the nodes in cluster 335 may all include a variety of resources that can be allocated (either directly on a node or via a network connection) to one or more shards. Outside the cluster, different clients or users 331 and 333 may be configured to access the system.

In another aspect, the system described herein monitors its tasks at all times. For example, instrumentation may be included for measuring the time it takes to perform various low-level steps of the workload (for instance, indexing a single document). Another mechanism aggregates these measurements into a statistic that represents the resource needs of that portion of its workload. The system may also measure the time taken for indexing documents, performing search-related tasks, aggregations, refreshes, merge operations and using other workload components. In various embodiments, the disclosed system also keeps track of the storage space needed for each shard.

In other embodiments, the inventors have observed that modern operating systems (e.g., Linux, etc.) provide techniques for tracking certain resource usages, often at a high level of granularity. For instance, the operating system may report the time that individual threads are spent running on a CPU. Meanwhile, the system according to the disclosure may monitor the identity of the task each thread is performing at any time, which means that the system can, using its own resources and capitalizing on the operating system's resources, measure the CPU needs of individual pieces of work and distinguish these needs from time spent doing non-CPU work. An example of the latter category may include waiting for data to be read or written on durable storage.

In other embodiments, the search engine system disclosed herein can be equipped with additional capabilities to measure other resource usage types. In one embodiment, for example, the system may monitor the volume of data read from or written to durable storage or sent/received to/from other nodes over the network. These measurements can in turn be considered along with other measurements and data in determining an overall shard allocation, or in redistributing resources dynamically by removing resources from shards that have no reasonably anticipated need for them, and then reallocating those resources to shards where a greater need for the resources is present.

The processing system can partition a search workload based on results from an empirical analysis and distribute portions of the workload to a plurality of nodes, such as the example nodes shown in FIG. 3. Also, resources can be dynamically allocated to the shards in the various nodes based on the analysis and measurements relevant to the state of the system, processor usage, storage usage and requirements, RAM usage, and similar criteria. The processing system can further use a number of different criteria, including CPU usage, actual or anticipated indexing needs and random access memory requirements, etc.

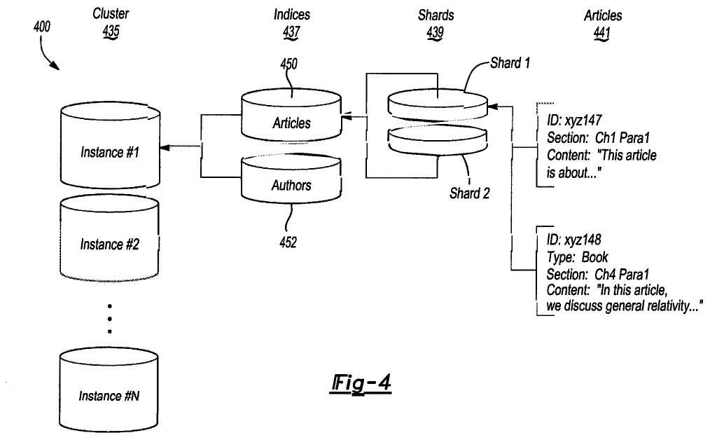

FIG. 4 is a conceptual diagram 400 of implementing data using shards on an instance of a cluster. Each node may represent a single instance. The cluster 435 may include a plurality of active instances 1, 2 . . . N as shown. In some embodiments, each instance may be individually available to a different client. As an example, a user at instance number 1 may be accessing the search engine. Depending on the search input, the user may be directed to indices 437 at a particular node in the cluster 435. Filtering may be used to find documents based on specific parameters. Querying is another technique used in the context of free text searches. In the example shown the indices may include an index 450 storing data on the subject matter expressed by or in articles and another index 452 storing data relevant to authors. The index 450 may include shards 439, which include a slice of the index, and which stores data and metadata relevant to the data. Shard 1 may lead the user to example articles 441, in which data with an identifier (e.g., xyz147), section (e.g., Ch. 1, Paragraph 1) and content may be maintained. The information may be ultimately output to the user as part of a search result. Shard 2 may lead the user to another example article with a distinct ID, as well as a type of article, section, and content.

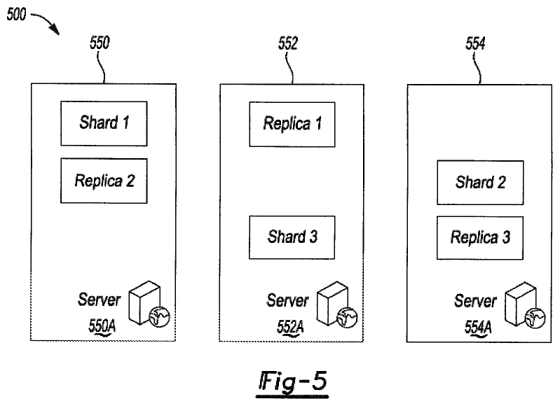

FIG. 5 is a block diagram 500 of different servers implementing shards and replicas of the shards. Example nodes 550, 552 and 554 may be included, respectively, on servers 550A, 552A and 554A. Thus, a cluster may include a collection of distributed servers in one or more locations. The nodes may be networked together using high-bandwidth, hardwired connections, wireless networks, or a combination thereof. Nodes may be physical or virtual. FIG. 5 includes another example of using replicas staggered on different machines. Shard 1 is present on node 550, with its replica on node 552 to ensure at least two points of redundancy. Similarly, shard 2 resides on node 554, with its replica on node 550. Shard 3 is on node 552 and has a replica 3 on node 554. In some embodiments, more than one replica may be used to ensure the data contained within the shards is properly backed up. In various embodiments, automatic monitoring and dynamic reconfiguration of redundancy scenarios can be included as a feature. Data relevant to this feature can be gathered to establish metrics for auto-scaling as well, since the greater the built-in redundancy, the more storage resources are needed.

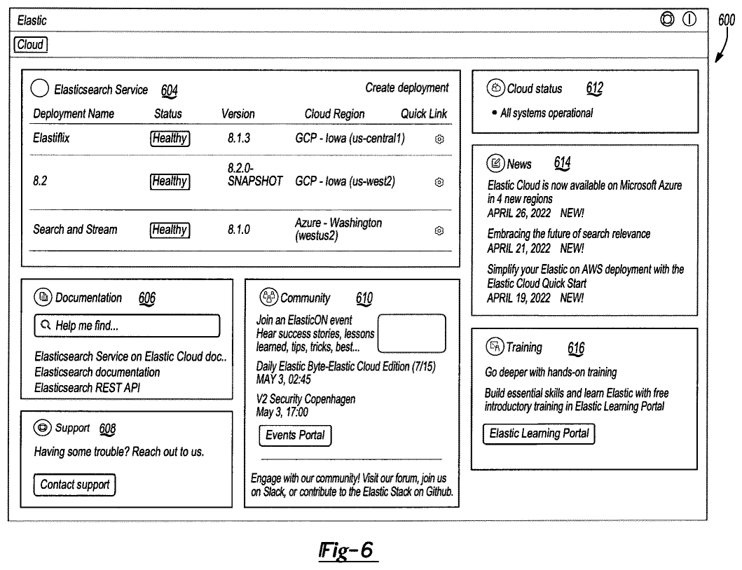

FIG. 6 is an example screen shot 600 of an Elasticsearch™ search engine user interface presenting various data and providing prompts to perform different actions. In various configurations, the user interface may be displayed on a monitor of a computing device operatively coupled to the cluster. As FIG. 6 illustrates, the search engine may in some configurations include a functional interface for displaying data relevant to other services that may be provided or offered alongside an enterprise search platform. For example, a service window 604 may display one or more search engine or other software-based deployments for use by a client. With each deployment, a corresponding operational status, version number, cloud location and a settings link is shown. These services may work in tandem with the distributed search engine in some cases, or in other cases they may be independent of it.

The interface may also include standard items including a documentation window 606 for assistance in a deployment (or use) of the search engine, a window 608 for contacting support, and an example community window 610 in which relevant excerpts about products or services related to the software tools may be displayed. The interface may enable an employee such as an information technology (IT) coordinator to monitor the status of the cloud that may be used for storage as well as indexing for use on the cluster. A news window 614 and a training window 616 are added features in this sophisticated implementation. A window 612 identifying the status of the cloud may be used to alert users of downtimes for the cloud and other problems. It will be appreciated that the user interface shown in FIG. 6 is for background purposes, and the specific details of the interface may in practice vary widely from the interface shown, all without departing from the spirit and scope of the present disclosure.

### Prediction of Future Resource Needs

Conventional search-based systems often build models of the predicted future load based on a simple “steady-state” model in which the future resource needs are assumed to be no greater than the maximum observed resource needs observed over a fixed past time period: for instance, seven days or the like. To this end, shards may be grouped together into “data streams.” The search system typically operates under the assumption that the workload model applies consistently across each data stream. Like in above configurations, new shards in a data stream are assumed to have similar resource needs to those of older shards. The principles of the present disclosure recognize, however, that the workload for individual shards in a data stream is not the same in general and may change dramatically over time. This renders the assumptions invalid in most cases. Examples of such workload changes include where one or more shards cease to be the primary write index for the data stream. These shards may instead transition between tiers including “hot,” “warm,” and “cold” shards, for example. For purposes of this disclosure, “hot” shards are in a tier where they are receiving the brunt of the indexing workload. Similarly, “warm” shards may receive little to no indexing traffic but may be the recipient of a relatively large number of searches. Still older “cold” shards may be receiving no indexing traffic and even fewer searches relative to those of warm shards.

To accommodate these different tiers of shards, another aspect of the present disclosure may use artificial intelligence or machine learning techniques, as noted with reference to FIG. 2. Because these techniques are configured to analyze the consequences of their decisions on a repeated bases, they can record relevant and useful patterns that can be repeated under the appropriate circumstances. As applied to future resource needs, aspects of this system use machine learning to build a more complex predictive model of future resource needs. Instead of relying on basic assumptions that shards or data streams share a common workload as time progresses, aspects of the present disclosure may rely on machine learning and may leverage underlying operating system capabilities to construct a search engine model that explicitly takes into account periodic workload variations. In some configurations, new assumptions derived from a tangible empirical analysis including machine learning and monitoring of new and different behaviors may be applied periodically to change predictive assumptions about the future. These analyses and resulting predictions may advantageously account for diurnal, weekly, monthly or seasonal cycles. They may be invaluable tools to understand behavior of the system over time, allowing the system to periodically make updates consistent with the behavior.

### Computation of Overall Desired Allocation

Given the current and predicted future resource needs of each shard and the available resources on each node, aspects of the system then compute the target allocation of shards to nodes. This computation may be treated as an optimization problem. In various embodiments, the system seeks the allocation of shards to nodes which has optimal balance subject to constraints arising for each type of resource. Resource-related constraints may include, for example, that for each node of a given collection of nodes, the total storage space allocated to the shards of that node does not exceed the node total storage capacity. Various strategies for solving this kind of optimization problem can be selected. For example, in some embodiments, various search engine technologies may use one or both of a local-search algorithm or a hill-climbing algorithm. Generally, these procedures start from a current allocation of shards. They then may iteratively attempt to find small changes, typically individual shard movements, which improves the balance of the cluster without violating any constraints.

The above computation is time-consuming. Thus, search engines may perform it asynchronously. The computation may depend on various inputs, including the resource needs of each shard and the available resources on each node in the cluster. These inputs may change over time. When the inputs change, conventional search engines may compute a new desired allocation of shards to reflect the new inputs. In so doing, these engines may assume that most changes in its inputs are small. The engines may consequently use the previous desired allocation of shards as a starting point for its iterative computations so that minor changes in its inputs yield small changes in the resulting allocation. If there is an ongoing computation when the new inputs are received, then conventional engines may pause the ongoing computation, adopt the new input data, and resume the computation where it left off.

Once the system has completed this computation, it must reconcile the actual and desired allocations of shards by creating, removing, and relocating shards within the cluster. The reconciliation process costs time and computational resources. The desired allocation should take these reconciliation costs into account. For example, the system should avoid computing a desired allocation which requires an excess of shard movements to realize.

Accordingly, in other aspects, the search engine system may employ a different strategy for solving the optimization problem. These strategies may apply a mathematical optimization techniques including Mixed-Integer Linear Programming (MILP), Constraint Solvers, and SAT or (satisfiability modulo theory) SMT solvers. SAT and SMT solvers are algorithms configured to solve a Boolean or mathematical satisfiability problem.

As noted, these computations may run on the elected master node in the cluster. As noted, the elected master node is responsible for the overall management and coordination of the cluster. In some embodiments, the computations may be performed on a different node. In one configuration, a node with more computational resources may be identified for use in performing the computation. In other embodiments, the system may instead distribute the computation across multiple nodes to make use of their collective computational resources. In either case, these intensive computations may be executed on machines in the cluster that have superior processing resources, either through the sophistication of a single nodes or by way of using a plurality of two or more nodes to run elements of the computation in parallel. In so doing, a greater number of factors and constraints may be taken into account when performing the allocation. In addition, the use of multiple nodes to perform the computation can decrease the duration of the computation.

### Progressive Reconciliation of Actual and Desired Allocation

Current search engines may compute the difference between the current and desired allocation of shards across nodes. Using the results of this information, the system may then perform some prescribed number of actions that brings the current allocation closer to the desired one. For example, if the system observes that a certain shard X is currently allocated to node A and the desired allocation of shard X is on node B, then the system may commence the relocation of shard X from node A to node B. Similarly, if shard Y is currently not allocated in the cluster and the current target allocation for shard Y is node C, then the system may determine a preference to create a copy of shard Y on node C. If, however, example shard Z is currently allocated to node D, but it has no desired location or target allocation, then the system may choose to remove shard Z from node D.

The above-referenced allocation computations and resulting actions may take significant time (minutes or even hours) to complete. When an ongoing action is completed, these current search engines may compute the next actions to perform, and the extended process repeats. With this iterative reconciliation process, the current allocation of shards eventually matches the target allocation. At each step, these conventional search engines only select actions which do not violate any constraints. For example, a search system will not attempt to relocate shards if those relocations exhaust the target node's disk capacity.

In the event the target allocation changes while a search engine is still in the midst of reconciling the cluster, then beginning on the next iteration of the reconciliation process, the system starts to select actions that move towards the new target allocation. A limit exists to the computational resources to which the cluster has access. In some situations, there may be insufficient capacity in the cluster to allocate all shards. Moreover, a robust distributed system should be designed to be resilient to the failures of individual components such as a node. That is, the loss of a node from the cluster should not reduce its overall capacity. Even if the cluster has sufficient capacity when fully operational, enough spare capacity should be present in the cluster to support its workload even after the loss of a node. Conversely, as in aspects of the present disclosure, clusters should not carry too much spare capacity, because the operational costs of a cluster scale with its size and resources may be excessive and too many spare resources may be undesirable as a result.

The system disclosed herein may expose information about the capacity it needs to operate. This information may be computed in various embodiments based on the workload it observes, including the storage size of each shard and the estimated (fractional) number of CPUs required for the indexing workload of each shard. Other considerations can be taken into account.

In further aspects of the disclosure, an auto-scaling process is disclosed that automatically scales the cluster allocation based on an extended set of variables. Current scaling techniques in search engines have been limited to scaling based solely on the storage size. In these aspects, auto-scaling of the cluster can be automatically performed based on estimated needs not merely by assessing storage needs, but also by estimating CPU or processing system needs for indexing operations. Because indexing is such a major part of the overall computational process, cluster auto-scaling can increase its predictive accuracy by eliciting information about existing and anticipated indexing needs.

In this extended auto-scaling procedure, the system extends the set of variables considered in the workload computation. In some embodiments, the new variable set may also take into account the amount of random access memory needed for each shard allocated (or to be allocated) and the fractional number of CPUs needed to adequately accommodate the currently anticipated search workload. This new variable set advantageously will enable the system to take predictive measures in allocating the cluster that are much more precise, and much closer to the actual resource needs. Other variables related to indexing, queries, and past auto-scaling results may also be taken into account.

### Automatically Adjust Sharding Strategy

The automated techniques according to aspects of the disclosure include, where appropriate, changing the number of shards over which the processing system can spread certain portions of the workload. For example, it may not be possible for any one node to support the entire workload of a particular data stream. Accordingly, by increasing the number of shards in each index in the data stream, the system can access more resources by spreading the workload out over a larger number of nodes. In a similar manner, if the workload for a data stream decreases, then the system may maintain overall efficiency by reducing the number of shards in each index of the data stream. In some embodiments, the system automatically adjusts strategies in allocating shards in response to changes in the workload.

Among other advantages, the proposed solutions compute the desired balance or target allocation, and iteratively reconcile towards the target. The desired allocation can be determined in the background by an entity other than the nodes performing the indexing and search retrieval operations. This freedom allows the designers of the system to implement a suite of more sophisticated algorithms that take into account additional information beyond mere storage space. This information can include the loads and sizes of individual shards, the overall computational power of the cluster, the amount of memory needed for each shard, and the like. Armed with this additional information characterizing the state of the system, the system can perform more accurate and effective optimization iterations. Because in practice different shards require drastically different resources, these additional optimization iterations, based on additional considerations, may result in a more even and balanced consumption of resources across the cluster.

Another advantage of the aspects disclosed herein relates to the compact nature of the operations. In an example case involving a series of shard create/modify/delete operations, the processing system can in some embodiments perform a single computation towards a target allocation. The system can in some embodiments proceed to perform a single reconciliation operation (or a single set of such operations) towards the target allocation. This automated analysis and subsequent action in manipulating the shards and nodes beneficially saves computation time and resources. These actions also can minimize the number of expensive shard move operations, which in turn reduces the time an even spread is achieved. This result in performing measured, calculated operations based on a diverse data set characterizing the cluster stands in contrast with conventional search engine approaches, the latter of which are more closely characterized by sporadic and reactive movements of shards as a set of “knee-jerk” responses to their creation.

Reconciliation may be performed against the desired or target allocation model rather than in response to individual operation (e.g., in a series of changes). Because a target allocation is known, it is possible to expose the percentage of completed move operations towards that target in addition to a balanced/imbalanced current state description. Further, as noted, allocating shards according to their resource usage advantageously ensures that nodes are not overloaded and therefore that requests are not rejected due to overload situations. Automatically scaling the cluster up/out ensures that the cluster has enough capacity for the workload. Automatically scaling the cluster down/in ensures that the cost of running the cluster can adapt once a previous peak workload no longer occurs.

In performing an analysis that takes into account different measurements and parameters, the present system need not engage in reactive shard allocation with high resource usage on a newly added node(s), since the analysis takes into account resource consumption as well, on a shard and node level. As a result, clusters are less vulnerable to the resource utilization hot spots that historically had to be resolved by human intervention to manually spread shards on different nodes. The expense of this avenue and the downtime associated with it renders the present disclosure particularly beneficial.

That is to say, conventional search engines typically rely on a much simpler methodology of computing next shard allocation based on the current state in response to every change, rather than an analysis-based approach that relies on empirical data, as in the present disclosure. These existing techniques, which are strictly reactive and focused on resolution of immediate resource issues, cannot achieve an even resource consumption that maximizes both performance and cost efficiency, as is disclosed herein. Further, unlike these conventional systems, the present disclosure is fully compatible with batching allocation computations. The system of the present disclosure further monitors reconciliation progress and reports the state of this progress relative to the target allocation. Unlike conventional systems, aspects of the disclosed system include in its analyses additional beneficial components including statistics collection and orchestration communication to automatically add or remove nodes to ensure that resource utilization is sufficient while remaining economical.

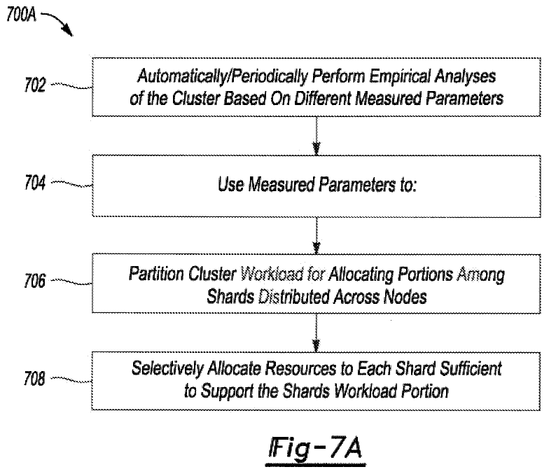

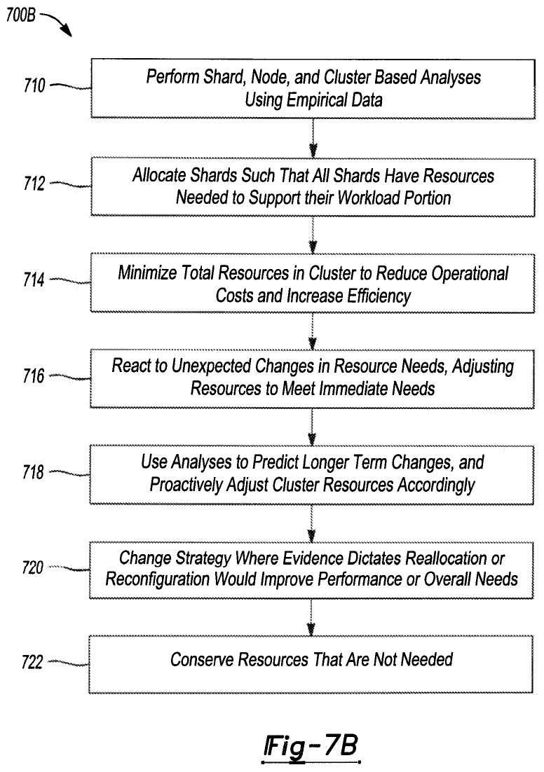

FIG. 7A is a flowchart 700A illustrating example techniques for resource-sensitive shard allocation and auto-scaling according to various embodiments. The techniques in this flowchart may be performed by a processing system such as processing system 117 shown in FIG. 1. The processing system, as noted, may be distributed in more than one location and may include one or more processors, servers or other computing machines, depending on the details of the implementation. In some cases, the processing system may allocate certain steps to various nodes or other computing devices, while allocating other steps to other nodes or computers. Further, in some embodiments, the processing system may be included within an orchestrator device, such as the example orchestrator 825 below. In other embodiments, the processing system may be included on a master eligible node, such as one or more of nodes 311-313 in FIG. 3. The processing system may be included on coordinating node 337, or on a more sophisticated version thereof. The processing system may be located in a central location, as a single server or a plurality of servers. The processing system may be part of a single node, or it may use processing resources from more than one node. In some embodiments, the processing system may be implemented on a workstation, personal computer, laptop computer, or portable or mobile devices, the latter categories generally more relevant to smaller or more resource-modest implementations of the search engine. Even when the processing system is housed on one or more servers, the processing system may be networked to potentially any location worldwide to allow authorized individuals to monitor the progress or status of the system from time to time. In this case, smaller devices may be used to intervene with the search tools and make manual configurations to aspects or features of the search engine or related services/software where necessary or appropriate.

With reference to FIG. 7A, the automated system may be configured to perform an initial allocation. It is assumed for the purpose of this example embodiment that the databases have been established and the search engine is operational. The processing system is used to monitor the progress and status of various facets of the cluster and associated components, as described above. The workload may be a dynamic, ever-changing variable that can be ascertained by the system at relevant moments of time. The workload may shift in either direction depending on a wide variety of factors, including the number of users at any given time.

Referring initially to step 702, the processing system may be configured to automatedly analyze the cluster based on a plurality of measured parameters. In various embodiments, automatic monitoring may include parameters relating to storage, random-access memories, the health and status of nodes in the cluster, indexing, searches, and the like. The data may be statistical in nature, such as measuring the amount of incoming data that may need to be indexed and cumulatively noting the increases or decreases. The parameters may be measured as time parameters, such as the times relevant events transpired, the length of time for different threads to perform various actions, the duration of searches, etc. The parameters may also include values and amounts, such as, for example, the amount of RAM allocated to different shards, the actual amount of indexing that has occurred versus other tasks for each node in the cluster, and other factors relating both to the actual occurrence of events, and to events to be predicted in the future based on current data. As one example of step 702, the processing may measure the resources allocated to each shard to determine whether the resources may be excessive, or conversely inadequate.

It should be appreciated that the term “periodically” for purposes of this disclosure is not limited to just measurements at fixed times, but it may more broadly encompass multiple measurements made in a time period. Referring still to step 702, the processing system may use these parameters, or portions of them, to conduct an analysis of various features of the system. In some aspects of the disclosure, the processing system may consider whether it is appropriate to auto-scale the cluster, nodes in the cluster, indices in the node, nodes in the shard, etc. to add resources where necessary and to remove from shards resources that are not in use and not likely to be used in the foreseeable future, for example. The processing system may also analyze whether it should automatically perform other tasks as described herein. In general, the choice of parameters to measure in various embodiments may depend on whether the measurements are relevant to the analyses conducted by the processing system. If a broad spectrum of actions may be undertaken by a more sophisticated system, a greater number of parameter types are more likely to be relevant. Conversely, if the processing system is tailored to execute algorithms for adjusting resources only, for example, then less parameters may need to be measured. In some embodiments, the types of parameters that are measured may change for different analyses and at different times. The processing system may advantageously be a self-learning processing system, using artificial intelligence features to improve its competency in balancing the resources of the cluster as time progresses.

At step 704, the processing system transitions from its analyses to use of the data for performing actions. The actions are generally automated, but also may take into account manual input by an operator when adding new features that may affect operation of the system. Referring to step 706, the processing system may partition an existing workload, which includes reconfiguring an existing workload, among shards across the nodes. In some embodiments, the processing system may also reconfigure the cluster for optimal performance by adding or removing nodes, and auto-scaling shards and nodes up or down depending (at least in part) on the measured parameters from the analyses.

Similarly, at step 708, the processing system may selectively allocate resources to each shard, such that the allocated resources are based on the needs of the shard and therefore are sufficient to support the portion of the total workload handled of the shard. Here again, in various embodiments, the processing system may auto-scale the system by allocating or reconfiguring the number, size, and distribution of shards across nodes in the cluster. The processing system may do so using the measurement results. Steps 706 and 708 may, but need not, be performed in the order identified, and instead may be performed, in whole or in part, in reverse order. As described herein, and unlike prior implementations, the automated allocation of resources to the shards is configured to take into account the needs of individual shards. In this manner, the allocation can be proportional to the workload portion of the shard. Excessive allocations of needless resources can be avoided for shards that lack a large workload. By the same token, shards that need more resources at the time of the analyses can be apportioned more resources.

Accordingly, rather than performing the strictly reactive ad hoc fixes of conventional systems that were limited in scope, the processing system can perform reconciliations of the actual and target allocations using a smoother and quicker set of well-calculated analyses. The processing system can still react to changes as well as adjusting the allocation such that predictive behavior is accommodated in advance.

FIG. 7B is a flowchart 700B illustrating example techniques for resource-sensitive shard allocation, auto-scaling, and implementations of particular techniques according to various embodiments. The steps in FIG. 7B may be performed by the processing system in a similar manner as described with respect to FIG. 7A. At step 710, the processing system may proceed to perform shard, node, and cluster based analyses using empirical data obtained from measuring parameters as above. The parameters may be measured as part of instructions issued by various algorithms. Some parameters may be measured using dedicated hardware or application-based instrumentation. An operator may initially deploy the system to perform analyses at different time periods, such as periodically. The system may additionally or alternatively be deployed in response to some trigger or flag from the network indicating that a quota has been reached, or that a reallocation is otherwise necessary. In some cases, after the system is established and initially configured, the system may be substantially completely automated. The analyses in step 710 may include measuring various shard-specific parameters, such as their size, workload portion, and resources. Node and cluster-based analyses may be performed using empirical data at step 710 as well.

At step 712, the processing system may use the information obtained in step 710 along with other information (such as self-learnt information, operator input if needed, etc.) to allocate, reallocate, or redistribute shards. This step may entail an initial allocation of shards when a distributed search engine is in the setup phase. This step may alternatively entail allocating new shards to an existing implementation, removing shards from the implementation, redistributing computing resources among the shards, etc. In an aspect of the disclosure the shards are allocated such that all shards have sufficient computational resources necessary to support their respective workloads, but without an overage of unnecessary resources that otherwise can be allocated to another shard or task.

At step 714, the processing system may take measures to minimize the total resources in the cluster in an overall effort to reduce operational costs and increase efficiency. This step 714 may in some embodiments be part and parcel with step 712, meaning that in some embodiments, the allocation/reallocation steps are performed with this objective underpinning the process. The processing system may, as noted, execute these algorithms in a manner that ensures that no node is left deprived of immediate resources it needs to perform tasks, However, step 714 can help ensure that overallocated shards are reconfigured accordingly. Tailoring the system to conserve resources stands to benefit the owner of the system, since any given system can achieve a close to ideal balance that saves resources, which can be financially favorable to the owner that may be leasing server space and/or cloud resources, for example, for use with such a system.

At step 716, the processing system may be configured to also react to unexpected changes in resource needs. For example, resources can be prioritized and adjusted to meet immediate needs. Unlike in prior implementations which are strictly reactive and ad hoc in nature, however, the system according to aspects of the present disclosure can be reactive when necessary while also being forward-focused, i.e., persevering in its gradual progression to reconcile the cluster to achieve a desired or target allocation. Step 716 may account for the fact that sudden changes are sometimes inevitable, and they need to be addressed.

At step 718, the processing system may augment its allocation and scaling actions by using the results of its analyses to predict longer term changes. Unlike current architectures, the system of the present disclosure in some aspects can perform longer term predictions and can make adjustments to the system based on those predictions. For example, data may be gathered that represents trends in user behavioral patterns, e.g., based on parameters including usage scenarios or popular searches. In some embodiments as noted, the analyses may be supplemented with feedback based on self-learning features of the processing system. The processing system can, in short, act proactively to perform allocations that accommodate future needs. In so doing, the processing system can shift its target allocation to take into account predictions backed with sufficient reliability. These target allocations can include individual allocations to shards based on their current workload, resources, and predicted future workload and resources.

At step 720, the processing system may elect to change a strategy any time the empirical evidence based on measured parameters and other factors dictate that a reallocation of the current cluster or a reconfiguration of the shards' workload portion or computing resources can improve performance or overall needs of the system. Thus, while the processing system is well-positioned to avoid making ad hoc fixes based on perceived deficiencies, the processing system may be nevertheless equipped to change system allocations that are no longer deemed useful, or to correct or remedy a situation such as reallocating unused resources from one set of shards to another. Thus, in addition to its automated monitoring and reconciliation capabilities, the system can still make adjustments to correct issues that require correcting. Another key benefit of the processing system is that the frequency of emerging needs warranting quicker changes can be dramatically reduced based on all of the above attributes of the system. Quick fixes are less likely to be needed.

At step 722, the processing system, when determining a target allocation and progressively reconciling the current allocation towards the target, may do so subject to the total amount of resources and the need for conserving them. Thus, the processing system in step 722 may perform reallocations that remove the availability of resources from shards that are not using them. Step 722 need not be a separate procedure, but like the other steps of FIG. 7B, it may be performed as one facet of the overall goal. That is to say, the processing system may perform a single set of procedures at a time, in which the various factors discussed above, including the desire to conserve resources, are collectively taken into account to choose or update a target allocation and to perform a set of allocations commensurate with the new target. This is one significant advantage of aspects of the present disclosure: the processing system can use its analyses and measurements to make global changes that take into account all the different factors for balancing the overall computational load and can do so in an automated fashion via its periodic measurements of relevant data and ensuing analyses of that data.

FIG. 8 is an example diagram 800 of an external orchestrator 825 used for configuring a cluster 839 in accordance with various embodiments. Orchestration is the automated configuration and management of a cluster of nodes or applications. In this embodiment, orchestrator 825 may be a server or set of servers that encompasses the processing system. However, orchestrator 825 may in other embodiments reside on one or more nodes in the cluster 839. Here, it is assumed that nodes 829, 841 and 857 are data nodes that includes indices, shards and replicas thereof. Node 859 may also include data, but further includes an interface for receiving and processing instructions from orchestrator 825 and for executing code or initiating hardware for conducting measurements. The allocation workload and the measurements can be localized at node 859 in some configurations and spread out across more devices in others. The nodes in cluster 839 are networked together, such as via high-bandwidth cable connections, optical fiber, Ethernet, or any other suitable networking scheme. As shown by lines between orchestrator 825 and node 859, the cluster 839 is duly connected/networked to the orchestrator 825 in embodiments where, as here, the two are distinct.

Orchestrator 825 may receive information over connection 843 such as measured parameters that reflect the target capacity or target allocation. Orchestrator 825 may include a database that may reside on durable storage 113 coupled to processing system 117 (FIG. 1). The database may include the target capacity information, historical data stored from prior measurements, analyses results, and other information that details information relevant to the cluster 839. That information may include older data characterizing the historical status of the cluster and, in some embodiments, data acquired via self-learning. The code used for running the suite of algorithms is also included in storage.

The orchestrator 825 may receive the target capacity information 843 and related data parameters upon issuing instructions to node 859. After performing its analysis, the orchestrator 825 may communicate instructions to node 859 via connection 845 to reconfigure the cluster to add or remove nodes. In various embodiments, the actual reconfigurations may be performed among different ones of the nodes in the cluster. The necessary information concerning the new allocations, or the terminated ones is conveyed to the orchestrator 825 for storage in a database.

The terms “comprising”, “including,” and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. “A,” “an,” “the”, “at least one”, and “one or more” are used interchangeably to indicate that at least one of the items is present. A plurality of such items may be present unless the context clearly indicates otherwise. All numerical values of parameters (e.g., of quantities or conditions), unless otherwise indicated expressly or clearly in view of the context, including the appended claims, are to be understood as being modified in all instances by the term “about” whether or not “about” actually appears before the numerical value. A component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims. Although several modes for carrying out the many aspects of the present teachings have been described in detail, those familiar with the art to which these teachings relate will recognize various alternative aspects for practicing the present teachings that are within the scope of the appended claims. It is intended that all matter contained in the above description or shown in the accompanying drawings shall be interpreted as illustrative and exemplary of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

What is claimed is:

1. A system for a distributed search engine, comprising:
a cluster comprising a plurality of networked nodes, the cluster having a workload; and
at least one master node including a processing system configured to automatedly analyze the cluster based on a plurality of measured parameters, and to use results of the analysis to:
allocate shards across the nodes;
partition a workload for allocating portions thereof among the shards, and
selectively allocate resources to the shards sufficient to support the workload portions.

2. The system of claim 1, wherein the processing system is configured to measure individual resource needs of the shards for selectively allocating the workload portions of the cluster or further resources, respectively, to individuals ones of the shards.

3. The system of claim 1, wherein the workload comprises indexing, searching, and aggregations.

4. The system of claim 1, wherein the plurality of measured parameters includes one or more of shard, node, or cluster-based: durable storage use or needs; indexing data; searching data; aggregation data; random access memory use or needs; times to perform tasks; thread data; refreshes; merges; read times; write times; processor statistics; or metadata relevant to any foregoing one of the parameters.

5. The system of claim 1, wherein the processing system is further configured to aggregate the plurality of measured parameters into statistics for use in predicting future allocations.

6. The system of claim 1, wherein the processing system is further configured to predict future resource needs for each of the shards according to the results from the plurality of measured parameters.

7. The system of claim 1, wherein the processing system is further configured to determine a target allocation of shards to the plurality of nodes in the cluster, wherein each of the shards is allocated resources from the cluster needed for the shard based on the respective workload portion.

8. The system of claim 7, wherein the processing system is further configured to periodically reconcile a current allocation of shards in the cluster towards the target allocation.

9. The system of claim 7, wherein the processing system is further configured to revise the target allocation of the shards to another target allocation in response to identifying changes in the resources allocated from the cluster to one or more of the shards.

10. The system of claim 7, wherein the processing system is further configured to revise the target allocation of the shards to another target allocation in response to identifying changes in a workload of the cluster.

11. The system of claim 1, wherein the processing system is further configured to add or remove one or more of the plurality of nodes in the cluster while preserving sufficient resources for shards affected by the addition or removal.

12. The system of claim 1, wherein the processing system is further configured to adjust the resources allocated to each node while preserving sufficient resources for shards affected by the adjustment.

13. The system of claim 1, wherein the processing system is further configured to adjust a strategy used to partition the workload of the cluster when the analysis shows that a new strategy will improve performance or reduce resources needed by the cluster or the plurality of nodes located therein.

14. The system of claim 1, further comprising an orchestrator configured to auto-scale the cluster, the auto-scaling comprising adding or removing nodes based on (i) actual or anticipated storage needs of the cluster, and (ii) actual or anticipated indexing needs of the cluster.

15. The system of claim 14, wherein the orchestrator is further configured to auto-scale the cluster based on the amount of random access memory (RAM) needed for the shards.

16. The system of claim 15, wherein the orchestrator is further configured to auto-scale the cluster based on a number of processors needed to manage a current workload in the cluster.

17. The system of claim 1, wherein the resources include at least one of:
one or more central processing units (CPUs) or hardware computational resources;
durable storage;
random access memory (RAM);
cache memory; or
network resources.

18. A system for a distributed search engine, comprising:
a cluster comprising a plurality of networked nodes, the cluster having a workload assigned to shards in portions across the nodes; and
at least one master node including a processing system configured to periodically analyze the cluster based on a plurality of measured parameters, and to use results of the analysis to:
reallocate shards across the nodes when needed to improve performance or efficiency;
allocate or reconfigure the workload portions among one or more of the shards, and
selectively allocate or reconfigure resources to the shards sufficiently to support respective workload portions.

19. The system of claim 18, wherein the processing system is configured to auto-scale the cluster, the auto-scaling comprising adding or removing nodes to the cluster.

20. A method for auto-managing a cluster, comprising:
assigning a workload to shards in respective portions across a cluster, the cluster comprising a plurality of networked nodes;
initially allocating the shards across the nodes in the cluster;
periodically analyzing the cluster based on a plurality of measured parameters;
based on results of the analyses, auto-scaling the cluster, the auto-scaling comprising (1) reallocating the shards across the nodes when needed to improve performance or resource efficiency, (2) adding or removing one or more of the nodes when needed to correlate the cluster with the workload, and (3) allocating or reconfiguring the workload portions among one or more of the shards when needed to balance the cluster; and (4) selectively allocating or reconfiguring resources to the shards sufficient to support the respective workload portions.
